(19) United States
(12) Patent Application Publication
(10) Pub. No.: US 2004/0209793 A1
(43) Pub. Date: Oct. 21, 2004

(54) Encapsulated liquid detergent composition

(76) Inventor: Daniele Fregonese, Ludwigshafen (DE)

Correspondence Address: Norris McLaughlin & Marcus, 30th Floor, 220 East 42nd Street, New York, NY, 10017, US

(21) Appl. No.: 10/478,470

(22) PCT Filed: May 24, 2002
(86) PCT No.: PCT/GB02/02444

(30) Foreign Application Priority Data
May 25, 2001 (GB) 0112779.4

(51) Int. Cl. C11D 17/00

(52) U.S. Cl. 510/439

(57) ABSTRACT

The present invention relates to liquid detergent compositions which are encapsulated in a polymer, especially compositions that contain ingredients capable of cross linking a water-soluble polymer.

The present invention relates to liquid detergent compositions which are encapsulated in a polymer, especially compositions that contain ingredients capable of cross linking a water-soluble polymer.

Liquid detergent compositions comprising surfactants are known. Such compositions can be used, for example, for laundry use, for example for fine-fabric laundry use or for heavy duty laundry use, or as hand or machine dishwashing compositions. They may also be used in liquid toilet rim blocks and as hard surface cleaners.

It is known to package chemical compositions, particularly those which may be of a hazardous or irritant nature, in films, particularly water-soluble films. Such containers can simply be added to water in order to dissolve or disperse the contents of the container into the water.

For example, WO 89/12587 discloses a package which comprises an envelope of a water-soluble material which comprises a flexible wall and a water-soluble heat seal.

The package may contain an organic liquid comprising, for example, a pesticide, fungicide, insecticide or herbicide.

WO 92/17382 discloses a package containing an agrochemical comprising a first sheet of non-planar water-soluble or water-dispersible material and a second sheet of water-soluble or water-dispersible material superposed on the first sheet and sealed to it.

Such arrangements have, however, a number of difficulties. In particular, certain types of chemicals cannot be included within the polymer container which may cause cross linking of the polymer and alteration of its properties. For example, desirably containers are made from poly(vinyl alcohol) (PVOH) which is water-soluble and easily manufactured by a number of techniques into suitable containers for liquid detergents, such as by thermoforming, injection moulding or blow moulding. However, the inclusion of a compound capable of cross-linking the water-soluble polymer in detergent composition may alter the properties of the water-soluble container, making it less water-soluble.

A number of solutions have been proposed to this problem; EP0291198 suggests using a copolymer with the PVOH which is a non-hydrolysable anionic comonomer. EP0079712 suggests using low Mw PVOH films to increase the water solubility of the PVOH under such conditions.

We have found that by the preparation of a substantially anhydrous detergent liquid composition we are able to add compound(s) capable of cross linking the water-soluble polymer of the container into the detergent composition without appreciable affecting the cross-linking of the water-soluble polymer container.

Desirably certain compounds may be added to liquid detergents for a number of reasons which may be active polymer cross linkers, a good example is the use of boron containing compounds for stabilising enzymes in liquid detergent compositions.

By the term “substantially anhydrous” we mean that the total water content, preferably the free water content, is less than 5% by weight, ideally less than 1% by weight, of the liquid composition.

By the use of the term “free water content” we mean that water is present which is not chemically or physically bound within the liquid detergent composition. Therefore, higher amounts of water can be present in the liquid detergent composition provided that it is chemically or physically bound. In order to determine the amount of free water present in a composition, a standard loss-on-drying determination test may be carried out. A sample of the composition, 10 g, is weighed, and then maintained at 60° C. for 3 hours under a partial vacuum of 200 mbar (20 kPa). The sample is then re-weighed, and the weight lost determined. In the present invention, the loss on drying the first composition must be less than 5 wt %, preferably less than 4, 3, 2 or 1 wt %.

Types of compounds that may cause cross linking of a water-soluble polymer are those that contain at least two functional group wherein each functional group is capable of binding the water-soluble polymer of the container. Examples of compounds which are classed as cross-linking compounds but can be included in formulations are inorganic acids, such as boric acid; borax (Na₂B₄O₇·10H₂O); urea; trimethylamine; oxalic acid; dimethylolurea; glyoxal; diepoxides; divynil sulfone; metal salts, such as salts of copper (cupric ammonium); nickel, chromium and titanium organics; and water soluble formaldehyde derivatives.

A key ingredient commonly used are perborate based compounds, which act as bleach precursors. Levels of such agents may be up 10% wt, but are preferably less than 7% wt, 5% wt, 3% wt of the composition.

Accordingly the present invention provides a water-soluble polymer container in which is present a liquid detergent composition comprising:

a) a surfactant, and

b) a compound capable of cross-linking the water-soluble polymer;

which liquid detergent is substantially anhydrous.

A further feature of the invention is a method of cleaning fabric which method comprises introducing a water-soluble polymer container, as defined herein, into a wash bath.

The term “water-soluble” is taken to include water dispersible.

The pH of the composition is desirably 7.5 or less.

However, it is also desirably not too acidic, especially when the composition is used for laundry use. In such instances the pH is desirably at least 5, more desirably at least 5.5 and most desirably at least 6.0. However, compositions for other uses, such as toilet cleansers where an anti-limescale effect may be desirable, may have a lower pH, for example a pH of 5 or less, especially 4 or less.

The pH of the composition is measured when the composition has been dissolved in a large quantity of water. Thus the pH is measured when the composition is dissolved in water such that the final composition contains 5 wt % of the composition of the present invention and 95 wt % water. More accurate results are obtained by measuring the pH of the composition after it has been diluted because in some instances concentrated surfactants may interfere with pH measurement. Furthermore this enables the pH of an anhydrous composition to be measured.

The pH may be controlled by, for example, adding an acid or a base, or a buffer.

Suitable acids are, for example, organic acids such as acids containing from 1 to 6 carbon atoms and from 1 to 4, for example 2 or 3, acid groups such as carboxylic acid groups. Examples of such acids are citric acid and acetic acid. Other suitable acids are organic acids such as hydrochloric acid, sulfuric acid and boric acid.

Suitable bases are, for example, alkali metal, alkaline earth metal or ammonium hydroxides, carbonates or bicarbonates. Suitable alkali metals are sodium or potassium. Suitable alkaline earth metals are calcium and magnesium. Organic bases may also be used, such as amines substituted with from 1 to 4, such as 2 or 3, organic groups such as alkanol groups, for example methanol, ethanol, propanol or isopropanol groups. Desirably the amine is monoethanolamine, diethanolamine or triethanolamine or a mixture thereof. Particularly desirable is a mixture of monoethanolamine and triethanolamine, for example in a weight ratio of from 1:1 to 1:2, particularly 1:1.25 to 1:1.75, such as 1:1.5, which may also lead to enhanced generation of foam.

The container of the present invention can simply have one compartment or two or more compartments.

The containers which contain two or more compartments or composition can have a particularly attractive appearance because they contain two compositions, which are advantageously held in a fixed position in relation to each other. The compositions can be easily differentiated to accentuate their difference. For example, the compositions can have a different physical appearance, or can be coloured differently. Thus, for example, the containers can have an appearance of a fried egg or eyeball.

Such a container may contain two components which are incompatible with each other. It may also contain a component which is incompatible with the part of the container enclosing the other component. For example, one composition may be incompatible with the part of the container enclosing another composition.

The inner compartment may be fixed to the outer compartment, or may be free. Such containers can be produced by any method, for example by forming the outer compartment, filling it with the desired composition and the pre-prepared inner compartment, and then sealing the outer compartment. The outer compartment and the inner compartment can be produced by any method. Examples of suitable methods by which each compartment may be independently prepared are vertical form fill sealing, thermoforming and injection moulding.

It is also possible to produce containers in which the two or more compartments are held in a fixed spatial relationship to each other. Such containers may be prepared by, for example, thermoforming or injection moulding, or a combination thereof.

The container of the present invention may have at least two compartments, for example 2, 3 or 4 or more.

For a multi-compartment container, it is possible to ensure that the components are released at different times. Thus, for instance, one composition can be released immediately the container is added to water, whereas the other may be released later. This may be achieved by having a compartment which takes longer to dissolve surrounding one of the compositions. This may be achieved, for example, by having different compartment wall thicknesses. Alternatively, the one composition may simply be held on the outside of the container, for example on the receptacle part or on the sealing member, in which case it can start to dissolve as soon as the article is added to water. It may also be achieved by choosing compartment walls which dissolve at different temperatures, for example the different temperatures encountered during the cycle of a laundry or dish washing machine.

Injection moulding can, for example, be used to form a container, which is then filled with the desired composition and sealed, for example with a film or injection-moulded rigid closure. Desirably the film or closure dissolves before the rest of the container to release the composition. It is possible to incorporate more than one compartment in the container by use of a suitably shaped injection mould.

The walls of the injection moulded container generally have a thickness greater than 100 μm, for example greater than 150 μm or greater than 200 μm, 300 μm, 500 μm, 750 μm or 1 mm. Desirably, however, the walls have a thickness of from 200 to 400 μm.

A preferred polymer which is already in a form suitable for injection moulding is a poly(vinyl alcohol) (PVOH) sold in the form of granules under the name CP1210T05 by Soltec Developpment S.A. Paris, France. A PVOH may be moulded at temperatures of, for example, from 180 to 220° C., depending upon the formulation selected and the melt flow index required.

Containers produced by injection moulding can be provided with two or more compartments by an appropriate mould shape.

The container can be sealed with, for example, one or more water-soluble films or other sealing means as described below.

Thermoforming techniques have been described in, for example, WO 92/17382 and WO 00/55068. It is possible to incorporate more than one compartment by a variety of techniques, for example by the technique disclosed in WO 93/08095. It is also possible to use a film incorporating a second compartment or component as a closure film, or to place a previously prepared compartment or component at the bottom of a thermoforming mould before the main container is prepared.

The container may, for example, be formed of a film. The film may be a single film, or a laminated film as disclosed in GB-A-2,244,258. The film may be produced by any process, for example by extrusion and blowing or by casting. The film may be unoriented, monoaxially oriented or biaxially oriented. If the layers in the film are oriented, they usually have the same orientation, although their planes of orientation may be different if desired.

The layers in a laminate may be the same or different. Thus they may each comprise the same polymer or a different polymer.

In a thermoforming or vacuum forming process an initial pocket is formed to contain the composition. The thickness of the film used to produce the pocket is preferably 40 to 300 μm, more preferably 50 to 200 μm, especially 55 to 160 μm, more especially 60 to 150 μm and most especially 80 to 120 μm. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. One skilled in the art can choose an appropriate temperature, pressure or vacuum and dwell time to achieve an appropriate pocket. The amount of vacuum or pressure and the thermoforming temperature used depend on the thickness and porosity of the film and on the polymer or mixture of polymers being used. Thermoforming of PVOH films is known and described in, for example, WO 00/55045.

A suitable forming temperature for PVOH or ethoxylated PVOH is, for example, from 90 to 130° C., especially 90 to 120° C. A suitable forming pressure is, for example, 69 to 138 kPa (10 to 20 p.s.i.), especially 83 to 117 kPa (12 to 17 p.s.i.). A suitable forming vacuum is 0 to 4 kPa (0 to 40 mbar), especially 0 to 2 kPa (0 to 20 mbar). A suitable dwell time is, for example, 0.4 to 2.5 seconds, especially 2 to 2.5 seconds.

While desirably conditions chosen within the above ranges, it is possible to use one or more of these parameters outside the above ranges, although it may be necessary to compensate by changing the values of the other two parameters.

It is possible, if desired, to place a secondary component in the cavity of a thermoforming mould before the container is formed in the usual way in the mould. The secondary component can stick to the container. The secondary component may, for example, be a compressed particulate solid or a container containing a secondary composition. A suitable container comprises a polymeric film containing a particulate solid, a gel or a liquid.

The container is generally made by producing a compartment by any of the techniques described herein. The compartment is then filled with the desired composition. The composition may have more than one phase. For example it may comprise an aqueous composition and a liquid composition which is immiscible with the aqueous composition. It may also comprise a liquid composition and a separate solid composition, for example in the form of a ball, pill or speckles.

After the compartment has been filled, a sealing member is may be placed on top of the compartment and sealed thereto.

The sealing member may be produced by, for example, injection moulding or blow moulding. It may also be in the form of a film.

The sealing member may simply consist of a water-soluble polymer. If it is desired to produce a multi-compartment container, in an embodiment of this invention the sealing member comprises a second composition at the time it is placed on top of the first compartment. This may be held or otherwise adhered on the sealing member. For example it can be in the form of a solid composition such as a ball or pill held on the sealing member by an adhesive or mechanical means. This is especially appropriate when the sealing member has a degree of rigidity, such as when it has been produced by injection moulding. It is also possible for a previously prepared container containing the second composition to be adhered to the sealing member. For example, a sealing member in the form of a film may have a filled compartment containing a composition attached thereto. The second composition or compartment may be held on either side of the sealing member such that it is inside or outside the first compartment.

Generally, however, the second composition is held within a second compartment in the sealing member. This is especially appropriate when the sealing member is flexible, for example in the form of a film.

The sealing member is placed on top of the first compartment and sealed thereto. For example the sealing member in the form of a film may be placed over a filled pocket and across the sealing portion, if present, and the films sealed together at the sealing portion. In general there is no or only one second compartment or composition in or on the sealing member, but it is possible to have more than one second compartment or composition if desired, for example 2 or 3 second compartments or compositions.

The second compartment in the sealing member may be formed by any technique. For example it can be formed by vertical form fill sealing the second composition within a film, such as by the process described in WO 89/12587. It can also be formed by having an appropriate shape for an injection moulding.

In general in any multi-compartment container of the present invention, the first compartment and the second compartment (or composition if not held within a compartment) have a volume ratio of from 2:1 to 20:1, preferable 4:1 to 10:1.

The thickness of the film comprising the second compartment may also be less than the thickness of the film making up the first compartment of the container of the present invention, because the film is not subjected to as much localised stretching in the thermoforming step. It is also desirable to have a thickness which is less than that of the film used to form the first compartment to ensure a sufficient heat transfer through the film to soften the base web if heat sealing is used.

The thickness of the covering film is generally from 20 to 160 μm, preferably from 40 to 100 μm, such as 40 to 80 μm or 50 to 60 μm.

This film may be a single-layered film but is desirably laminated. The film may be the same or different as the film forming the first compartment. If two or more films are used to form the film comprising the second compartment, the films may be the same or different. Examples of suitable films are those given for the film forming the first compartment.

The first compartment and the sealing member may be sealed together by any suitable means, for example by means of an adhesive or by heat sealing. Mechanical means is particularly appropriate if both have been prepared by injection moulding. Other methods of sealing include infra-red, radio frequency, ultrasonic, laser, solvent, vibration and spin welding. An adhesive such as an aqueous solution of PVOH may also be used. The seal desirably is water-soluble if the containers are water-soluble.

If heat sealing is used, a suitable sealing temperature is, for example, 120 to 195° C., for example 140 to 150° C. A suitable sealing pressure is, for example, from 250 to 600 kPa. Examples of sealing pressures are 276 to 552 kPa (40 to 80 p.s.i.), especially 345 to 483 kPa (50 to 70 p.s.i.) or 400 to 800 kPa (4 to 8 bar), especially 500 to 700 kPa (5 to 7 bar) depending on the heat sealing machine used. Suitable sealing dwell times are 0.4 to 2.5 seconds.

One skilled in the art can use an appropriate temperature, pressure and dwell time to achieve a seal of the desired integrity. While desirably conditions are chosen within the above ranges, it is possible to use one or more of these parameters outside the above ranges, although it might be necessary to compensate by changing the values of the other two parameters.

The surfactant present in the composition is at least one surfactant chosen from anionic, nonionic, amphoteric, cationic and zwitterionic surfactants and mixtures thereof.

Anionic surfactants may include anionic organic surfactants, usually employed in soluble salt forms, preferably as alkali metal salts, especially as sodium salts. Although other types of anionic surfactants may be utilised, such as higher fatty acyl sarcosides, soaps of fatty acids (including metal soaps and amine soaps), preferred anionic surfactants are those which are described as of a sulfonate or sulfate type, which may be designated as sulf(on)ates. These include linear higher alkylaryl sulfonates (for example alkylbenzene sulfonates), higher fatty alcohol sulfates, higher fatty alcohol polyalkoxylate sulfates, olefin sulfonates, α-methyl ester sulfonates and paraffin sulfonates. An extensive listing of anionic detergents, including such sulf(on)ate surfactants, is given on pages 25 to 138 of the text Surface Active Agents and Detergents, Vol. II, by Schwartz, Perry and Berch, published in 1958 by Interscience Publishers, Inc. Usually the higher alkyl group of such anionic surfactants has 8 to 24 carbon atoms, especially 10 to 20 carbon atoms, preferably 12 to 18 carbon atoms, and the alkoxylate content of such anionic surfactants that are alkoxylated (preferably ethoxylated or ethoxylated/propoxylated) is in the range of 1 to 4 moles of alkoxy groups per mole of surfactant.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:

ROSO₃⁻M⁺

wherein R is a linear C₈-C₂₀ hydrocarbyl group and M is a water-solubilising cation. Preferably R is C₁₀-C₁₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:

CH₃(CH₂)ₓ(CHOSO₃⁻M⁺)(CH₂)ₘCH₃

wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:

CH₃(CH₂)ₓ(CHOSO₃⁻M⁺)CH₃ and

CH₃(CH₂)ₓ(CHOSO₃⁻M⁺)CH₂CH₃

for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:

RO(C₂H₄O)ₙSO₃⁻M⁺

wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium or potassium salts, and alkyl, for example C₈-C₁₈, benzene sulfonates.

Examples of nonionic surfactants are fatty acid alkoxylates, such as fatty acid ethoxylates, especially those of formula:

R(C₂H₄O)ₙOH

wherein R is a straight or branched C₈-C₁₆ alkyl group, preferably a C₉-C₁₅, for example C₁₀-C₁₄, alkyl group and n is at least 1, for example from 1 to 16, preferably 2 to 12, more preferably 3 to 10.

The alkoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol nonionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated nonionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further nonionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type.

The total content of surfactants in the composition is desirably 60 to 95 wt %, especially 75 to 90 wt %. Desirably an anionic surfactant is present in an amount of 50 to 75 wt %, the nonionic surfactant is present in an amount of 5 to 50 wt %, and/or the cationic surfactant is present in an amount of from 0 to 20 wt %. The amounts are based on the total solids content of the composition, i.e. excluding any solvent which may be present.

The compositions, particularly when used as laundry washing or dishwashing compositions, may also independently comprise enzymes, such as protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. Desirably the enzymes are independently present in the compositions in an amount of from 0.5 to 3 wt %, especially 1 to 2 wt %, when added as commercial preparations they are not pure and this represents an equivalent amount of 0.005 to 0.5 wt % of pure enzyme.

The compositions may, if desired, independently comprise a thickening agent or gelling agent. Suitable thickeners are polyacrylate polymers such as those sold under the trade mark CARBOPOL, or the trade mark ACUSOL by Rohm and Haas Company. Other suitable thickeners are xanthan gums. The thickener, if present, is generally present in an amount of from 0.2 to 4 wt %, especially 0.5 to 2 wt %.

Compositions used in dishwashing independently usually comprise a detergency builder. The builders counteract the effects of calcium, or other ion, water hardness. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred. Further builders are; phosphates such as sodium, potassium or ammonium salts of mono-, di- or tri-poly or oligo-phosphates; zeolites; silicates, amorphous or structured, such as sodium, potassium or ammonium salts.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan.

The builder is desirably present in an amount of up to 90 wt %, preferably 15 to 90 wt %, more preferable 15 to 75 wt %, relative to the total weight of the composition. Further details of suitable components are given in, for example, EP-A-694,059, EP-A-518,720 and WO 99/06522.

The compositions can also optionally comprise one or more additional ingredients. These include conventional detergent composition components such as further surfactants, bleaches, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners, and perfumes. If used, such optional ingredients will generally constitute no more than 10 wt %, for example from 1 to 6 wt %, the total weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt % of the compositions.

The compositions may optionally comprise materials which serve as phase stabilizers and/or co-solvents. Examples are C₁-C₃ alcohols such as methanol, ethanol and propanol. C₁-C₃ alkanolamines such as mono-, di- and triethanolamines can also be used, by themselves or in combination with the alcohols. The phase stabilizers and/or co-solvents can, for example, constitute 0 to 1 wt %, preferably 0.1 to 0.5 wt %, of the composition.

The compositions may optionally comprise components which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are NaOH and citric acid.

The above examples may be used for dish or fabric washing. In particular dish washing formulations are preferred which are adapted to be used in automatic dish washing machines. Due to their specific requirements specialised formulation is required and these are illustrated below

Amounts of the ingredients can vary within wide ranges, however preferred automatic dishwashing detergent compositions herein (which typically have a 1% aqueous solution pH of above 8, more preferably from 9.5 to 12, most preferably from 9.5 to 10.5) are those wherein there is present: from 5% to 90%, preferably from 5% to 75%, of builder; from 0.1% to 40%, preferably from 0.5% to 30%, of bleaching agent; from 0.1% to 15%, preferably from 0.2% to 10%, of the surfactant system; from 0.0001% to 1%, preferably from 0.001% to 0.05%, of a metal-containing bleach catalyst; and from 0.1% to 40%, preferably from 0.1% to 20% of a water-soluble silicate. Such fully-formulated embodiments typically further comprise from 0.1% to 15% of a polymeric dispersant, from 0.01% to 10% of a chelant, and from 0.00001% to 10% of a detersive enzyme, though further additional or adjunct ingredients may be present. Detergent compositions herein in granular form typically limit water content, for example to less than 7% free water, for better storage stability.

Non-ionic surfactants useful in ADW (Automatic Dish washing) compositions of the present invention desirably include surfactant(s) at levels of from 2% to 60% of the composition. In general, bleach-stable surfactants are preferred. Non-ionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

Preferably the ADW composition comprises at least one non-ionic surfactant. One class of non-ionics are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionic from a linear chain fatty alcohol with 16-20 carbon atoms and at least 12 moles particularly preferred at least 16 and still more preferred at least 20 moles of ethylene oxide per mole of alcohol.

According to one preferred embodiment the non-ionic surfactant additionally comprise propylene oxide units in the molecule. Preferably this PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of non-ionic surfactants includes reverse block copolymers of polyoxyethylene and polyoxypropylene and block copolymers of polyoxyethylene and polyoxypropylene initiated with trimethylolpropane.

Another preferred non-ionic surfactant can be described by the formula:

R¹O[CH₂CH(CH₃)O]ₓ[CH₂CH₂O]_{y}[CH₂CH(OH)R²]

wherein R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]ₓ[CH₂]ₖCH(OH)[CH₂]ⱼOR²

wherein R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x≧2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO) (EO), (EO)(EO) (PO), (EO) (EO) (EO), (PO) (EO) (PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different non-ionic surfactants is particularly preferred in ADW formulations for example mixtures of alkoxylated alcohols and hydroxy group containing alkoxylated alcohols.

The liquid detergent composition of the present invention may have a wide variety of uses. Thus it may be used, for example, as a laundry detergent composition, for example, for fine fabrics such as wool or for heavy duty laundry use such as for a normal wash. Alternatively the composition may be a wash booster for adding to the wash in addition to the usual detergent used. It may also be used as a hard-surface cleaner or in a liquid toilet rim block of the type described in EP-A-538,957 or EP-A-785,315. The composition may also be used as a hard-surface cleaning composition or as a liquid hand or machine dishwashing composition.

The present composition is especially suitable for use in a water-soluble container where the container is simply added to a large quantity of water and dissolves, releasing its contents. The favourable dissolution and dispersion properties of the composition of the present invention are particularly useful in this context.

A preferred additional additive is an enzyme, especially a protease, or a mixture of enzymes (such as a protease combined with a lipase and/or a cellulase and/or an amylase, and/or a cutinase, and/or a peroxidase enzyme). Such enzymes are well known and are adequately described in the literature (see WO 00/23548 page 65 to 68, which is incorporated herein by reference).

The enzyme will be present in an amount of, by weight, 0.1 to 5.0%, ideally 0.3% to 4.0% and preferably 1% to 3%.

A preferred protease is an enzyme Genencor Properase, supplied by Genecor, address is Gift Brocades, Delft, The Netherlands.

Desirably the water-soluble polymer is a poly(vinyl alcohol) (PVOH). The PVOH may be partially or fully alcoholised or hydrolysed. For example, it may be from 40 to 100% preferably 70 to 92%, more preferably about 88%, alcoholised or hydrolysed, polyvinyl acetate. When the polymer is in film form, the film may be cast, blown or extruded.

The water-soluble polymer is generally cold water (20° C.) soluble, but depending on its chemical nature, for example the degree of hydrolysis of the PVOH, may be insoluble in cold water at 20° C., and only become soluble in warm water or hot water having a temperature of, for example, 30° C., 40° C., 50° C. or even 60° C.

When the composition of the present invention is held in a water-soluble container, it desirably contains less than 5 wt % water, especially less than 3 wt %, 2 wt % or 1 wt % water. It may, however, contain more than 5 wt % water, although in this case precautions may have to be taken to ensure that the composition does not dissolve the water-soluble container before it is used, for example by ensuring that the composition contains a suitable amount of an electrolyte such as sodium chloride.

The containers of the present invention find particular use where a unit-dosage form of the composition is required. Thus, for example, the composition may be a dishwashing or laundry detergent composition especially for use in a domestic washing machine. The use of the container may place restrictions on its size. Thus, for example, a suitable size for a container to be used in a laundry or dishwashing machine is a rounded cuboid container having a length of 1 to 5 cm, especially 3.5 to 4.5 cm, a width of 1.5 to 3.5 cm, especially 2 to 3 cm, and a height of 1 to 2 cm, especially 1.25 to 1.75 cm. The container may hold, for example, from 10 to 40 g of the composition, especially from 15, 20 or 30 g to 40 g of the composition for laundry use or from 15 to 20 g of the composition for dishwashing use.

The viscosity of the composition of the present invention, measured using a Brookfield viscometer, model DV-II+, with spindle S31 at 12 RPM and at 20° C., is desirably 500 to 3000 cps, more especially 800 to 1500 cps, especially about 1100 cps.

Specific compositions described herein have a very low viscosity, despite having high surfactant contacts, and are a preferred feature of the invention having several advantages in handling and the filling of containers.

Low viscosity compositions are characterised in that they are made by changing the weight ratio sulfonic acid/nonionic, preferably the presence of a second surfactant causes the formation of mixed micelles that have a different aggregation behavior in terms of inter-micellar strength so the viscosity drops on decreasing the molar ratio of Sulfonic acid/nonionic. In the table are reported the data relating formula in which the overall content of surfactants is not changed but the ratio sulfonic acid/nonionic is decreased this is correlates with the viscosity determined with a Brookfield viscometer DV E spindle 1 speed 10 rpm Table (matrix: surfactants 38% enzyme 2%, glycerol 8%, Borax 2%, monopropylene glycol 40.9%, Kathon 0.1%, Peg 200 5%, coconut oil 2%, MEA 3.5%.) T=20° C., Brookfield DV-E, rpm 10, spindle 1.

| Viscosity | LAS¹/nonionic² |
|---|---|
| 300 | 0/38 |
| 80 | 15/23 |
| 185 | 30/8 |
| 300 | 38/0 |

¹sulfonic acid obtained with HF as catalyst;
²lialet 125-5 Condea.

Therefore preferred compositions have a low viscosity of less than 190 cps, ideally less than 100 cps, with a ratio of LAS to non-ionic of between 0.5:1 to 1:0.5 and, preferably, the total amount of surfactant is less than 50% wt of the composition.

The present invention is now further described in the following Examples in which all the parts are parts by weight unless otherwise mentioned.

### EXAMPLE 1

A laundry detergent booster composition

| | Parts |
|---|---|
| Lialet 125/5 (nonionic) | 23 |
| Petrusual 550 (lauryl alkyl sulfonate) | 15.5 |
| Genenco Properase (protease) | 2.0 |
| Glycerol | 8.0 |
| Borax (Na tetraborate decahydrate) | 2.0 |
| Monopropylene glycol | 42.0 |
| Kathon GC | 0.1 |
| PEG 200 | 5.0 |
| Coconut oil | 2 |
| Monoethanolamine (MEA) | 3.5 |

The following components were mixed together:

| | | |
|---|---|---|
| Monopropylene glycol | 42 | parts |
| PEG 200 | 5 | parts |
| Nonionic | 23 | parts |
| Kathon | 0.1 | parts |
| Coconut fatty acid | 2 | parts |
| LAS Solfodoc AC3-D | 15.5 | parts |

| | |
|---|---|
| MEA | 3.5 |

The temperature rose up to 60° C. and while the solution cooled to room temperature was prepared in a separated batch an enzymatic solution made with:

| | |
|---|---|
| Glycerol | 67 parts |
| Borax | 16.5 parts |
| Enzyme | 16.5 parts |

When the first solution was at room temperature were added 12 parts of the enzymatic solution under rapid stirring. At the end the dye is added 0.002 parts

### EXAMPLE 2-9

In a similar way to the preparation of Example 1 the following examples were prepared

Stability Test

| Ingredient | % Dosage |
|---|---|
| Lialet 125/5 (nonionic | 24.00 |
| Condea) | |
| LAS (sulfonic acid - | 15.5 |
| HF alkylation | |
| process) | |
| Properase 1600 | 2.00 |
| L (Enzyme from | |
| Genencor) | |
| Lilas (Dye) | 0.0002 |
| Glycerol | 8.00 |
| Borax | 2.00 |
| Monoprop. Glyc. | 41.40 |
| Kathon GC | 0.10 |
| (perservative Rohm | |
| and Haas) | |
| PEG 200 | 5.00 |
| Soap Coco | 2.00 |
| Total | 100.00 |
| Lialet 125/5 | 24.00 |
| (nonionic from | |
| Condea) | |
| LAS (sulfonic acid - | 20 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 36.9 |
| Kathon GC | 0.10 |
| (perservative form | |
| Rohm and Haas) | |
| PEG 200 | 5.00 |
| Soap Coco | 2.00 |
| Total | 100.00 |
| Lialet 125/5 | 24.00 |
| (nionionic | |
| surfactants) | |
| LAS (sulfonic acid - | 20 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 36.8 |
| Kathon GC | 0.10 |
| (perservative form | |
| Rohm and Haas) | |
| Lytron (opacisier) | 0.10 |
| PEG 200 | 5.00 |
| Soap Coco | 2.00 |
| Total | 100.00 |
| Lialet 125/5 | 24.00 |
| (nionionic | |
| surfactants) | |
| LAS (sulfonic acid - | 15.5 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 41.3 |
| Kathon GC | 0.10 |
| (perservative form | |
| Rohm and Haas) | |
| Lytron (opacisier) | 0.10 |
| PEG 200 | 5.00 |
| Soap Coco | 2.00 |
| | 100.00 |
| Lialet 125/5 | 24.00 |
| (nionionic | |
| surfactants) | |
| LAS (sulfonic acid - | 20 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 34.9 |
| Kathon GC | 0.10 |
| (perservative form | |
| Rohm and Haas) | |
| Aerosil 200 | 2.0 |
| (silica form | |
| Degussa) | |
| PEG 200 | 5.00 |
| Soap Coco | 2.00 |
| Total | 100.00 |
| Lialet 125/5 | 24.00 |
| (nionionic | |
| surfactants) | |
| LAS (sulfonic acid - | 20 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 36.8 |
| Kathon GC | 0.10 |
| (perservative form | |
| Rohm and Haas) | |
| Aerosil 200 | 2.0 |
| (silica form | |
| Degussa) | |
| Lytron (opacisier) | 0.1 |
| PEG 200 | 5.00 |
| Soap Coco | 2.00 |
| Total | 100.00 |
| Lialet 125/5 | 24.00 |
| (nionionic | |
| surfactants) | |
| LAS (sulfonic acid - | 15.5 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 41.3 |
| Kathon GC | 0.10 |
| (perservative form | |
| Rohm and Haas) | |
| Aerosil 200 | 2.0 |
| (silica form | |
| Degussa) | |
| Lytron (opacisier) | 0.1 |
| PEG 200 | 5.00 |
| Soap Coco | 2.00 |
| Total | 100.00 |
| Lialet 125/5 | 24.00 |
| (nionionic | |
| surfactants) | |
| LAS (sulfonic acid - | 15.5 |
| HF alkylation | |
| process) | |
| Properase 1600 L | 2.00 |
| (enzyme from | |
| Genencor) | |
| Lilas (Dye) | 0.0002 |
| Glycerol | 8.00 |
| Borax | 2.00 |
| Monoprop. Glyc. | 41.4 |
| Kathon GC | 0.10 |
| (perservative form | |
| Rohm and Haas) | |
| Aerosil 200 | 2.0 |
| (silica form | |
| Degussa) | |
| PEG 200 | 5.00 |
| Soap Coco | 2.00 |
| Total | 100.00 |

The formulation of Example 2 was contained in a heat sealed thermoformed pouch of PVOH (film type LX7D from Aquafilm and/or PT 60 from Aicello). The pouches were stored at 2°, 20° and 40° C. for 60 days. After the storage the film was intact and as soft as at the beginning of the storage. The enzyme in the formula was stable as shown in the table below.

| | 1 day | 30 days | 60 days |
|---|---|---|---|
| | Residue | Residue | Residue |
| Temperature | activity of | activity of | activity of |
| of storage | enzyme | enzyme | enzyme |
| 2° C. | 100% | 100% | 100% |
| 20° C. | 90% | 90% | 90% |
| 40° C. | 75% | 70% | 67% |

1. A water-soluble polymer container in which is present a liquid detergent composition comprising:
a) a surfactant, and
b) a compound capable of cross-linking the water-soluble polymer;
which liquid detergent has a free water content of less than 5% wt, determined by a log sample of the liquid detergent composition being heated at 60° C. for 3 hours under a partial vacuum of 20 kPa and has a pH of 7.5 or less and at least 5.

2. A water-soluble polymer container according to claim 1 wherein the free water content of the liquid detergent is less than 3% wt.

3. A water-soluble polymer container according to claim 2 wherein the free water content of the liquid detergent is less than 2% wt.

4. A water-soluble polymer container according to claim 1 wherein the water-soluble polymer is poly (vinyl alcohol).

5. A water-soluble polymer container according to claim 4 wherein the compound capable of cross-linking the poly(vinyl alcohol) is selected from; inorganic acids, such as boric acid; borax (Na₂B₄O₇·10H₂O); urea; trimethylamine; oxalic acid; dimethylolurea; glyoxal; diepoxides; divinyl sulfone; metal salts, such as salts of copper (cupric ammonium); nickel, chromium and titanium organics; and water soluble formaldehyde derivatives.

6. A water-soluble polymer container according to claim 4 wherein the compound capable of cross-linking the poly(vinyl alcohol) is a perborate based compound.

7. A water-soluble polymer container according to claim 4 wherein the compound capable of cross-linking the poly (vinyl alcohol) contains at least two functional groups wherein each functional group is capable of binding the water-soluble polymer of the container.

8. A water-soluble polymer container according to claim 1 wherein the liquid detergent composition contains less than 1% wt of free water.

9. A water-soluble polymer container according to claim in claim 8 wherein the liquid detergent composition loses less than 5% of its weight when a sample of 10 g of the liquid detergent composition is heated at 60° C. for 3 hours under a partial vacuum of 200 mbar.

10. A water-soluble polymer container according to claim 1 wherein the compound capable of cross-linking the water-soluble polymer is selected from; inorganic acids, such as boric acid; borax (Na₂B₄O₇·10H₂O); urea; trimethylamine; oxalic acid; dimethylolurea; glyoxal; diepoxides; divinyl sulfone; metal salts, such as salts of copper (cupric ammonium); nickel, chromium and titanium organics; and water soluble formaldehyde derivatives.

11. A water-soluble polymer container according to claim 10 wherein the compound capable of cross-linking the water-soluble polymer is a perborate based compound.

12. A water-soluble polymer container according to claim 10 wherein the compound capable of cross-linking the water-soluble polymer contains at least two functional groups wherein each functional group is capable of binding the water-soluble polymer of the container.
